(19) United States
(12) Patent Application Publication
(10) Pub. No.: US 2025/0131688 A1
(43) Pub. Date: Apr. 24, 2025

(54) INFORMATION PROCESSING METHOD, INFORMATION PROCESSING APPARATUS, AND STORAGE MEDIUM

(71) Applicant: CANON KABUSHIKI KAISHA, Tokyo (JP)

(72) Inventor: MASAKAZU KOBAYASHI, Tokyo (JP)

(21) Appl. No.: 18/920,134

(22) Filed: Oct. 18, 2024

(30) Foreign Application Priority Data
Oct. 18, 2023 (JP) 2023-179303

(51) Int. Cl. G06V 10/75; G06T 5/10; G06V 10/60

(52) U.S. Cl. CPC G06V 10/758; G06T 5/10; G06V 10/60; G06T 2207/20064

(57) ABSTRACT

An information processing method includes a conversion step of converting a captured image into first frequency characteristic data, a generation step of generating second frequency characteristic data by excluding data of a predetermined area from the first frequency characteristic data, and a determination step of determining whether or not the captured image is blurred based on the second frequency characteristic data. In the generation step, the predetermined area is determined according to whether or not the predetermined area falls within a predetermined range based on a statistic obtained based on the first frequency characteristic data.

### BACKGROUND

### Technical Field

The present disclosure relates to an information processing method, an information processing apparatus, and a storage medium.

### Description of Related Art

In the inspection of a building, in detecting abnormalities such as cracks from a captured image, the captured image is to be in focus and clear, and it is also to be an image in which camera blur did not occur during imaging. In detecting fine abnormalities in an inspection target area, a high-resolution image is required. For images that are used in the inspection of a large-scale structure, a plurality of high-resolution images are sometimes combined to generate a single combined image. Japanese Patent Laid-Open No. 2018-152737 discloses a method for determining abnormalities such as missing parts in image files that are used for combination, and for identifying an image that is to be re-captured according to the presence or absence of an abnormality.

### SUMMARY

An information processing method includes a conversion step of converting a captured image into first frequency characteristic data, a generation step of generating second frequency characteristic data by excluding data of a predetermined area from the first frequency characteristic data, and a determination step of determining whether or not the captured image is blurred based on the second frequency characteristic data. In the generation step, the predetermined area is determined according to whether or not the predetermined area falls within a predetermined range based on a statistic obtained based on the first frequency characteristic data. An information processing apparatus corresponding to the information processing method also constitutes another aspect of the disclosure. A storage medium storing a program that causes a computer to execute the above information processing method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of an information processing system according to each example.

FIG. 2 is a flowchart illustrating processing of the information processing apparatus according to each example.

FIG. 3 is a flowchart illustrating imaging processing according to each example.

FIGS. 4A and 4B explain a captured image and a combined image according to each example.

FIG. 5A explains a captured image list.

FIG. 5B explains a captured image list.

FIG. 5C explains a captured image list.

FIG. 6 is a flowchart illustrating imaging-condition determining processing according to each example.

FIG. 7 is a flowchart illustrating image-quality determining processing according to Example 1.

FIGS. 8A and 8B explain defocus maps according to each example.

FIG. 9 explains an abnormal luminance map according to Example 1.

FIG. 10 explains an exclusion map according to Example 1.

FIG. 11 explains a histogram of the first frequency characteristic according to Example 1.

FIG. 12 explains a specified area according to Example 1.

FIG. 13 explains an image to be re-captured according to each example.

FIG. 14 is a flowchart illustrating image-quality assessment processing according to Example 2.

FIG. 15 explains a defocus map according to Example 2.

FIG. 16 explains a setting screen according to each example.

FIGS. 17A, 17B, and 17C explain a defocus map according to Example 2.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of examples according to the disclosure. Corresponding elements in respective figures will be designated by the same reference numerals, and a duplicate description thereof will be omitted.

### Example 1

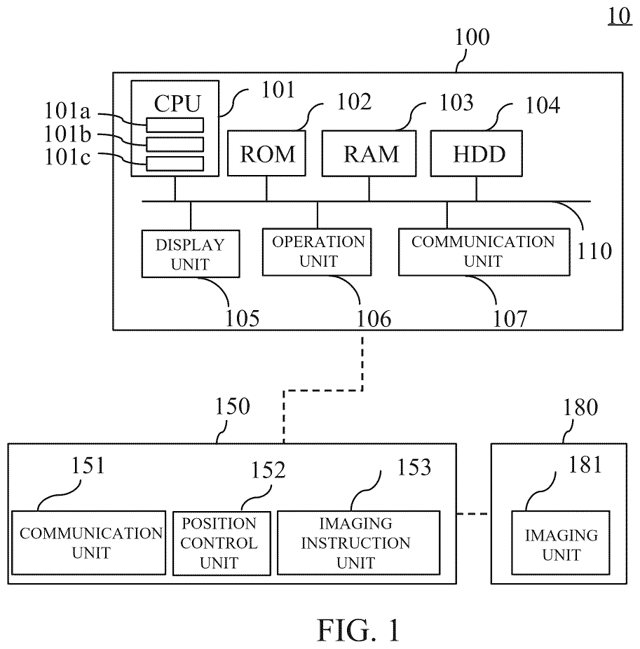

Referring now to FIG. 1, a description will be given of an information processing system 10 according to this example. FIG. 1 is a block diagram of the information processing system 10. The information processing system 10 includes an information processing apparatus 100, an imaging assisting apparatus 150, and an image pickup apparatus 180. The information processing system 10 executes an information processing method configured to determine the quality of a captured image and the necessity of re-capturing the image. The information processing system 10 is a system configured to inspect structures based on an image of the structure. Examples of the structures include, but are not limited to, bridges, tunnels, roads, buildings, dams, embankments, and electrical facilities. The information processing apparatus 100 is a device configured to control the entire imaging processing according to this example. The information processing apparatus 100 includes a CPU 101, a Read-Only Memory (ROM) 102, a Random Access Memory (RAM) 103, a hard disk drive (HDD) 104, a display unit 105, an operation unit 106, and a communication unit 107. The CPU 101 is a central processing unit that performs calculations and logical determinations for various processing and controls each component connected to the system bus 110. The CPU 101 has a converter 101a, a generator 101b, and a determining unit 101c.

The converter 101a converts a captured image into first frequency characteristic data. The generator 101b generates second frequency characteristic data by excluding data in a predetermined area from the first frequency characteristic data. The determining unit 101c determines whether the captured image is blurred from the second frequency characteristic data. The generator 101b further determines the predetermined area according to whether or not the predetermined area falls within a predetermined range based on a statistic obtained based on the first frequency characteristic data.

The ROM 102 is a program memory configured to store programs for control by the CPU 101, and includes various processing procedures described below. The RAM 103 is used as a temporary memory area such as a main memory and a work area of the CPU 101. A program memory may be realized by loading a program into the RAM 103 from an external memory connected to the information processing apparatus 100.

The HDD 104 includes a hard disk configured to store electronic data such as image data and programs according to this example. An external memory device may also be used to perform a similar function. Here, the external memory device may be realized, for example, by a medium (recording medium) and an external storage drive for realizing access to the medium. Examples of such media include flexible disks (FD), CD-ROMs, DVDs, USB memories, magneto-optical discs (MOs), and flash memories. The external memory may also be a server device connected via a network.

The display unit 105 is, for example, a liquid crystal display (LCD) or an organic electroluminescence display (OLED), and is a device for outputting images to a display screen. The display unit 105 may be an external device connected to the information processing apparatus 100 by wire or wirelessly. The operation unit 106 has a keyboard and a mouse, and accepts various operations by the user.

The communication unit 107 performs two-way communication by wire or wirelessly with other information processing apparatuses, communication devices, external memories, etc., using known communication technology. The communication unit 107 may be configured, for example, as a chip or antenna for public wireless communication. The communication unit 107 may also be configured to perform communication by other wireless communication methods such as wireless LAN and Bluetooth (registered trademark).

The imaging assisting apparatus 150 according to this example is a camera platform (panhead) device that can change an imaging position and imaging direction based on control from the information processing apparatus 100, and is mounted with an image pickup apparatus 180 described later. The imaging assisting apparatus 150 includes a communication unit 151, a position control unit 152 configured to control the imaging position and imaging direction, and an imaging instruction unit 153.

The communication unit 151 communicates with the information processing apparatus 100 wirelessly or by wire, and controls the imaging direction and imaging position and issues an imaging instruction according to instructions from the information processing apparatus. The communication unit 151 may be configured, for example, as a chip or antenna for public wireless communication. The communication unit 151 may be configured to communicate by other wireless communication methods such as wireless LAN and Bluetooth®.

The position control unit 152 changes the imaging position and imaging direction of the camera platform device so as to image an imaging area of an object to be inspected. The imaging instruction unit 153 controls imaging for the image pickup apparatus 180 set to the imaging position and imaging direction changed by the position control unit 152.

The image pickup apparatus 180 is an apparatus configured to perform imaging based on imaging instruction information received from the information processing apparatus 100 via the imaging assisting apparatus 150. The image pickup apparatus 180 has an entire image-plane phase-difference imaging sensor, and may record in-focus level (or degree) information (defocus value) of the captured image. The in-focus level information may be obtained by a method using infrared rays or a method using parallax images.

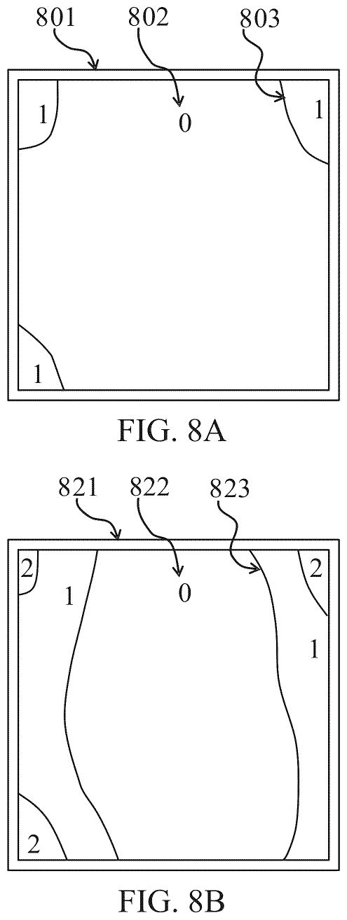

The in-focus level information will be described in detail later with reference to FIGS. 8A and 8B. A defocus value is data representing a spatial (two-dimensional) defocus-amount distribution in the imaging range. In the following description, the data representing the spatial defocus-amount distribution will be also called a defocus map. A defocus amount is a focus shift amount from a distance at which the optical system of the image pickup apparatus 180 is in focus. The defocus value (defocus map) illustrates a defocus amount as a spatial distribution for each pixel of the image.

Each pixel of the entire image-plane phase-difference imaging sensor of the image pickup apparatus 180 has two photoelectric converters, which will be referred to as divided pixels A and B. In the entire image-plane phase-difference imaging sensor, the images A and B are output as parallax images from the divided pixels A and B, which are two-dimensionally and regularly arranged. An image A+B obtained by adding the images A and B is recorded as a recorded still image. A defocus amount is calculated based on a phase difference between the parallax images. While a description will be given of an example configuration in which a defocus amount is derived on a pixel-by-pixel basis, the defocus amount may be derived for each predetermined area, such as a block unit having a plurality of pixels (for example, 5 pixels×5 pixels).

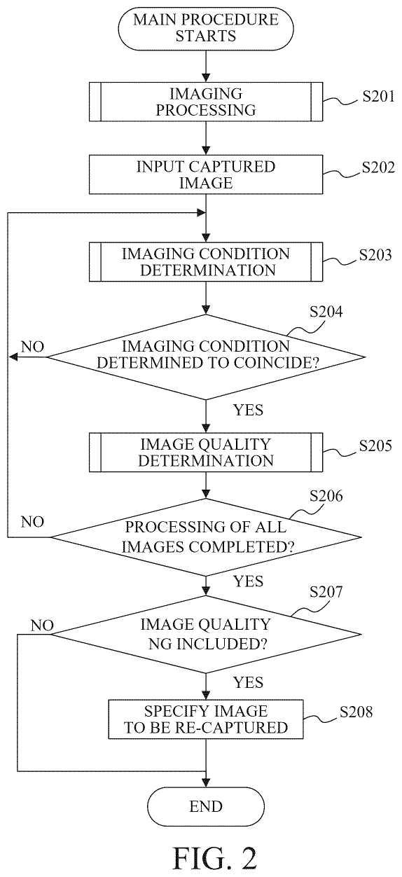

Referring now to FIG. 2, a description will be given of the processing of the information processing apparatus 100 according to this example. FIG. 2 is a flowchart illustrating the processing of the information processing apparatus 100. The flowchart illustrated in FIG. 2 is started by the information processing apparatus 100 executing an imaging processing control application.

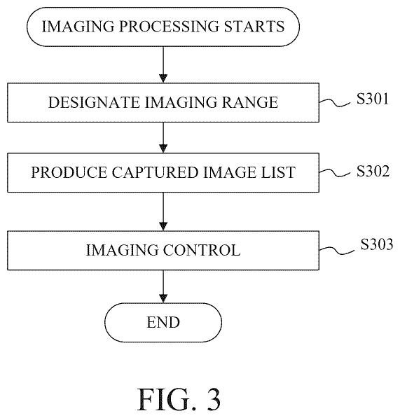

First, in step S201, the CPU 101 of the information processing apparatus 100 performs imaging processing. The imaging processing illustrated in step S201 is processing for operating the imaging assisting apparatus 150 and the image pickup apparatus 180 and performing imaging based on the control of the information processing apparatus 100. The imaging processing illustrated in step S201 will be described later with reference to the flowchart in FIG. 3.

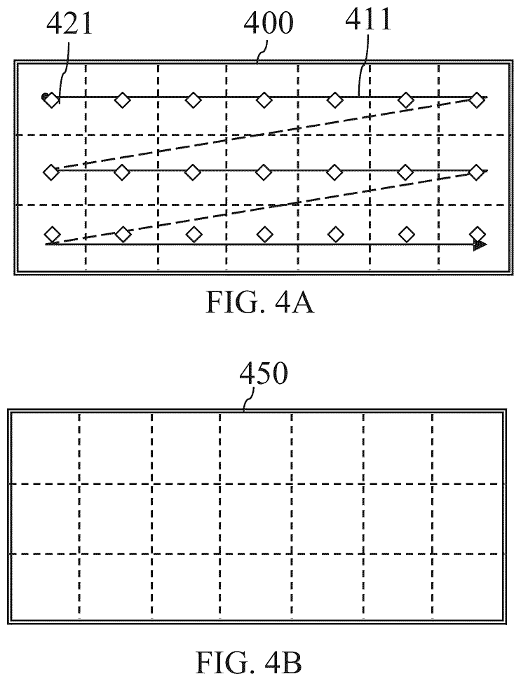

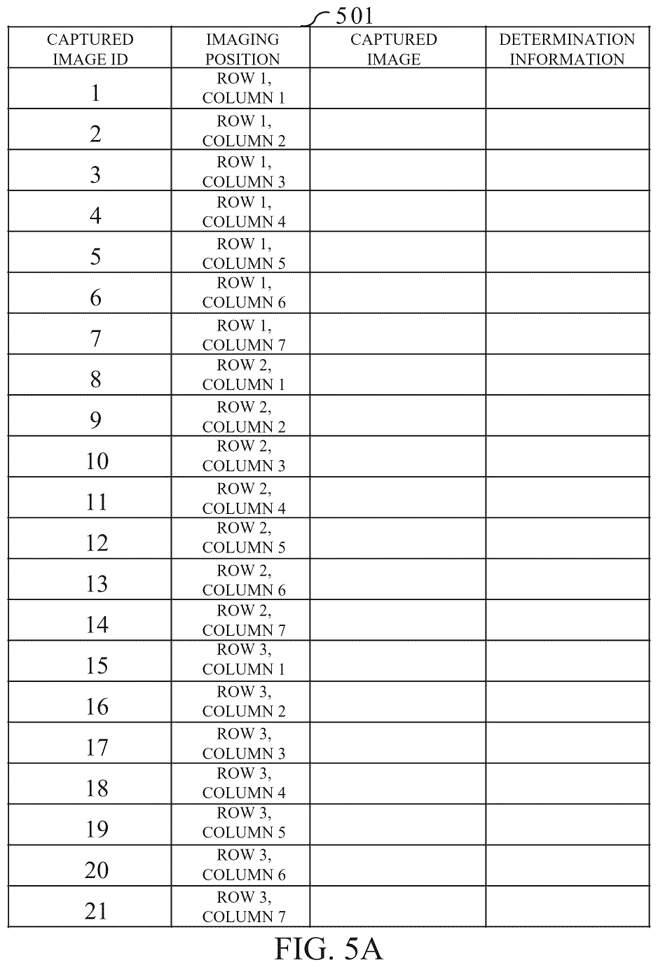

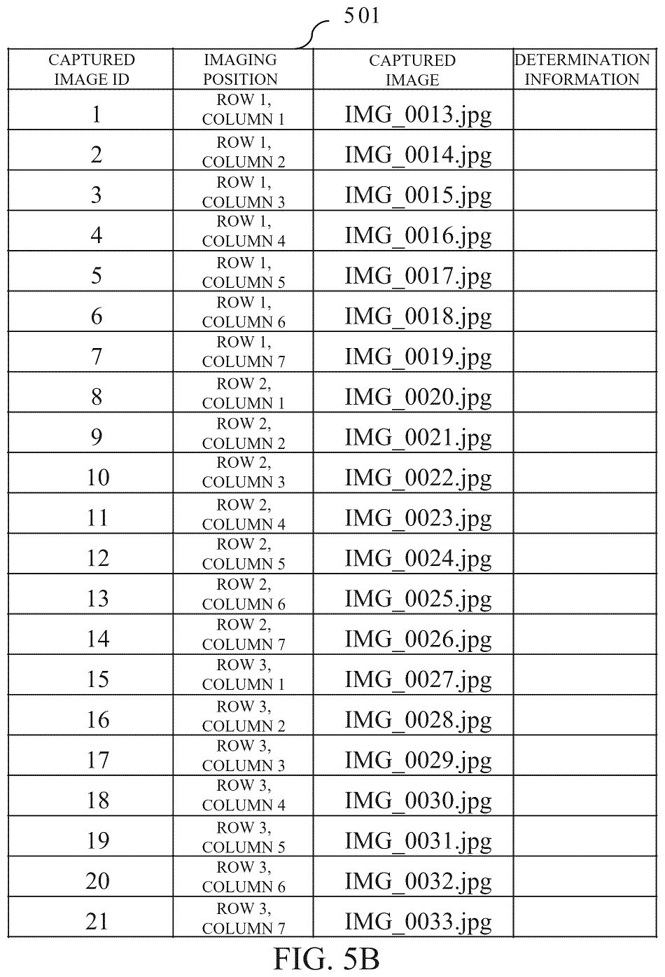

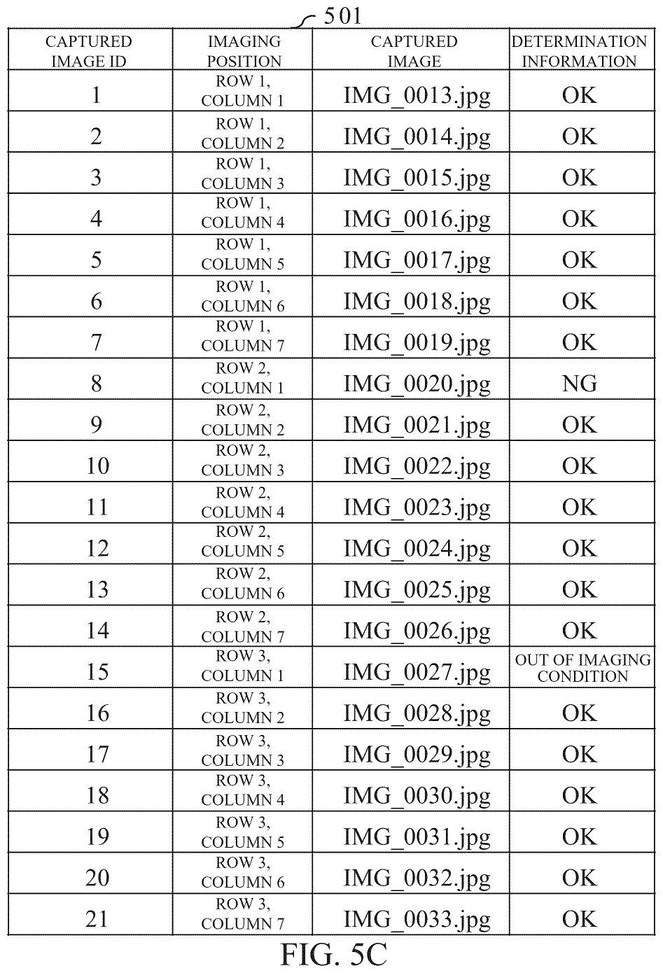

In step S201, the imaging range and the imaging position are designated in the order illustrated in FIG. 4A, the imaging assisting apparatus 150 is controlled, and the image pickup apparatus 180 is caused to perform imaging. In step S201, in a case where the information processing apparatus 100 receives a designation of an inspection range (imaging range) in a structure from a user, the information processing apparatus 100 creates a captured image list including information indicating the imaging range or the imaging position and imaging direction of the image corresponding to each record. The captured image list corresponds, for example, to a table 501 illustrated in FIG. 5A.

In step S201, the information processing apparatus 100 performs imaging in order based on the table 501. The information processing apparatus 100 can change the imaging range of the image pickup apparatus 180 by driving the imaging assisting apparatus 150 based on the table 501, which is the captured image list. In a case where the information processing apparatus 100 drives the imaging assisting apparatus 150 to change the imaging range, it transmits an imaging instruction to the image pickup apparatus 180 via the imaging assisting apparatus 150 so as to perform imaging. The image pickup apparatus 180 performs imaging according to the received imaging instruction.

In a case where capturing a single image is completed, the information processing apparatus 100 receives an imaging completion notification from the imaging assisting apparatus 150 or the image pickup apparatus 180. In a case where the information processing apparatus 100 receives the imaging completion notification, it writes information such as a captured image file name in the record of the captured image list corresponding to that imaging. Then, in order to perform the next imaging, it transmits information for changing the imaging direction by the imaging assisting apparatus 150 and an imaging instruction to the imaging assisting apparatus 150 and the image pickup apparatus 180, and performs imaging corresponding to the next record in the list.

Imaging is repeated until capturing images corresponding to the captured image list created in this way is completed. In a case where capturing all images corresponding to the captured image list is completed, the imaging processing ends.

After the imaging processing is completed, the table 501 illustrated in FIG. 5B is updated to include the captured image file names. The information processing apparatus 100 is configured to transmit information for driving the imaging assisting apparatus 150 and an imaging instruction for each image, but the disclosure is not limited to this example. For example, the information processing apparatus 100 may be configured to transmit information for capturing all images corresponding to records included in the table 501 as the captured image list all together (in a group) to the imaging assisting apparatus 150 and the image pickup apparatus 180. The information processing apparatus 100 may be configured to transmit information for capturing a plurality of images corresponding to the record included in the table 501 as the captured image list to the imaging assisting apparatus 150 and the image pickup apparatus 180. The imaging assisting apparatus 150 and the image pickup apparatus 180 may be configured to transmit information to be input to the table 501 as the captured image list all together to the information processing apparatus 100 after all imaging is completed.

FIG. 4A illustrates an imaging area (captured image) 400 of an inspection target surface of a structure to be inspected. FIG. 4A illustrates that a corresponding location on the inspection target surface is sequentially imaged, centered on an imaging position 421 indicated by a diamond-shaped rectangle, in a direction indicated by an arrow 411 relative to the imaging area 400. FIG. 4B illustrates a combined image 450 including the images sequentially captured in FIG. 4A. The combined image 450 is used to inspect the inspection target surface, that is, the imaging area 400.

Next, in step S202 of FIG. 2, the CPU 101 acquires the table 501 and the captured image file created in step S201. The subsequent processing from step S203 to step S205 is repeated for each of the acquired captured image files in the order of the captured image IDs listed in the table 501.

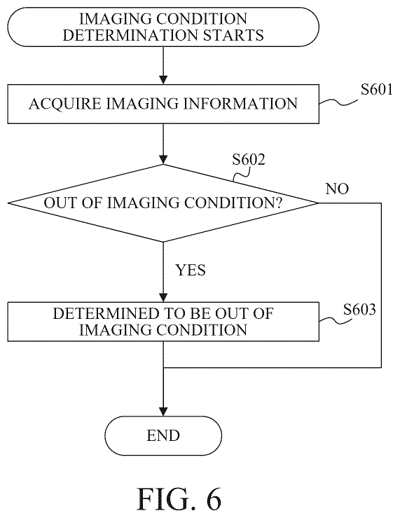

Next, in step S203, the CPU 101 performs imaging-condition determining processing to determine the imaging condition during imaging of the captured image. The imaging-condition determining processing will be described later with reference to FIG. 6. In the imaging-condition determining processing, in a case where the imaging condition of the determined captured image does not match the predetermined imaging condition, the imaging condition is recorded as “out of the imaging condition,” which is information indicating that the predetermined imaging condition is not met, in a determination information field of the corresponding captured image ID in the table 501. The result of this imaging-condition determining processing is used in re-capturing determination processing described later. That is, this example can determine whether or not re-capturing is necessary according to the imaging condition of a captured image. Furthermore, the determination processing of step S203 using the imaging condition can determine the captured image that needs to be re-captured without performing image-quality determining processing of step S205 described later. Performing the imaging-condition determining processing of step S203 that burdens a load lower than that of the image-quality determining processing of step S205 described later, in an earlier stage, can reduce the processing time.

An example of the imaging condition determined in step S203 can use an aperture value (F-number). The aperture value is an important imaging condition for obtaining an image with a deep depth of field and with less influence of “blur” due to diffraction. Therefore, in this example, it is determined that an image obtained by imaging at an aperture value other than the predetermined range or value is not to be used for predetermined image processing such as abnormality detection or combining processing for inspection, and re-capturing of the corresponding imaging area is necessary.

An example of the imaging condition determined in step S203 can use an ISO speed (sensitivity). In a case where the ISO speed in the imaging condition is too high, noise is likely to increase. In a case where an inspection is performed using an image with a lot of noise, the inspection accuracy is likely to reduce. Therefore, in this example, it is determined that an image obtained by imaging at an ISO speed other than the predetermined range or value is not to be used for predetermined image processing such as abnormality detection or combining processing for inspection, and re-capturing of the corresponding imaging area is necessary.

An example of the imaging condition determined in step S203 can use an object distance. In a case where the distance to the object during imaging is too far, an abnormality in a small object may not be detectable. Therefore, in this example, it is determined that an image obtained by imaging at an object distance other than the predetermined range or value is not to be used for predetermined image processing such as abnormality detection or combining processing for inspection, and re-capturing of the corresponding imaging area is necessary. The imaging condition determined in step S203 may have a condition set for at least one condition, and conditions may be set for each of a plurality of conditions.

Next, in step S204, the CPU 101 uses the determination result of step S203 to determine whether or not to proceed to processing in step S205 for the image to be processed. In a case where it is determined in step S204 that the captured image meets the predetermined imaging condition (Yes), the flow proceeds to step S205. On the other hand, in a case where the captured image does not meet the predetermined imaging condition (No), the flow proceeds to step S203, where processing is performed for the next captured image ID.

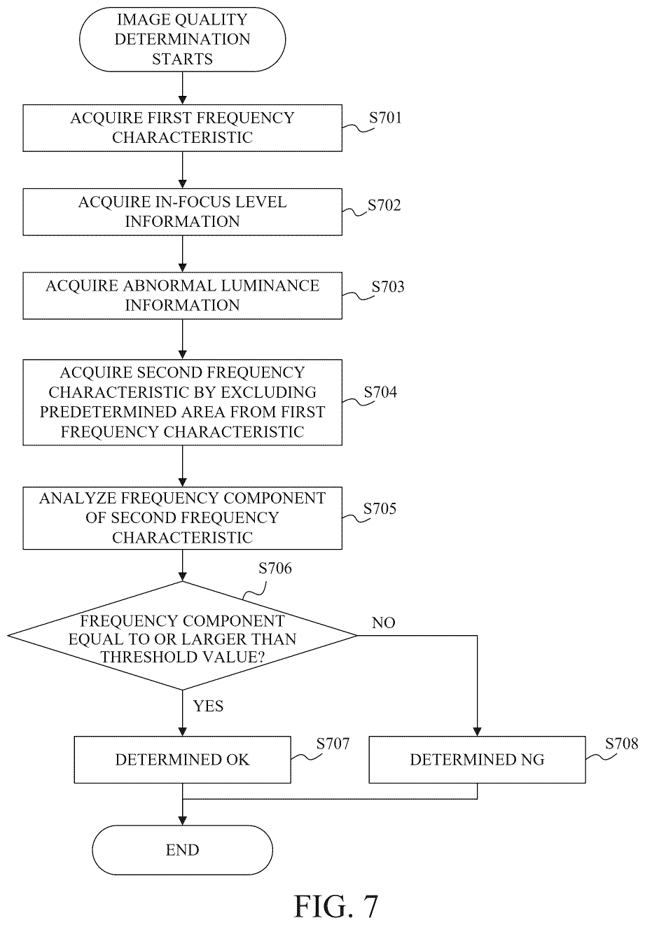

In step S205, the CPU 101 performs image-quality determining processing to determine the image quality of the captured image. The image-quality determining processing will be described later with reference to FIG. 7. The information processing apparatus 100 records the determination result of the image-quality determining processing in step S205 in the determination information field of the table 501 illustrated in FIG. 5C. For example, in a case where the image-quality determining condition is met, “OK” is recorded. On the other hand, in a case where the image-quality determining condition is not met, “NG” is recorded. In this example, the image quality is determined in the image-quality determining processing in step S205 using the frequency characteristic of the captured image. By using the frequency characteristic, the image quality degradation can be determined due to blur caused by the movement of the image pickup apparatus 180 under the influence of wind during the imaging processing.

Here, “blur” includes both defocus blur (out of focus) and camera blur (shake). Defocus blur refers to a state in which blur occurs because an object (a structure wall surface in the case of a bridge) is out of focus. On the other hand, camera blur refers to blur of a captured image caused by the movement of the image pickup apparatus body during exposure in imaging. For example, camera blur occurs in a case where the handheld image pickup apparatus moves vertically during exposure, or in a case where the image pickup apparatus mounted on an unmanned aircraft such as a drone shakes during flight.

Next, in step S206, the CPU 101 determines whether the image-quality determining processing in step S205 has been completed for all captured images input in step S202. In a case where the processing has been completed for all images (Yes), the flow proceeds to step S207. On the other hand, in a case where the processing is not completed (No), the flow proceeds to step S203, where the captured image with the next captured image ID is processed.

In step S207, the CPU 101 determines whether the determination information in the table 501 includes an image-quality determination result of “NG.” in a case where the determination information includes the image-quality determination result of “NG” (Yes), the flow proceeds to step S208. On the other hand, in a case where the image quality determination result of “NG” is not included (No), the flow ends.

In step S208, the CPU 101 specifies an image to be re-captured. In this example, the information processing apparatus 100 creates a combined image based on the imaging position and imaging range of each captured image, and presents the imaging position that requires re-capturing in the combined image to the user. An image for which the determination information in the table 501 is not OK is specified, and the imaging position and imaging range that require re-capturing in the combined image are presented based on the imaging position information.

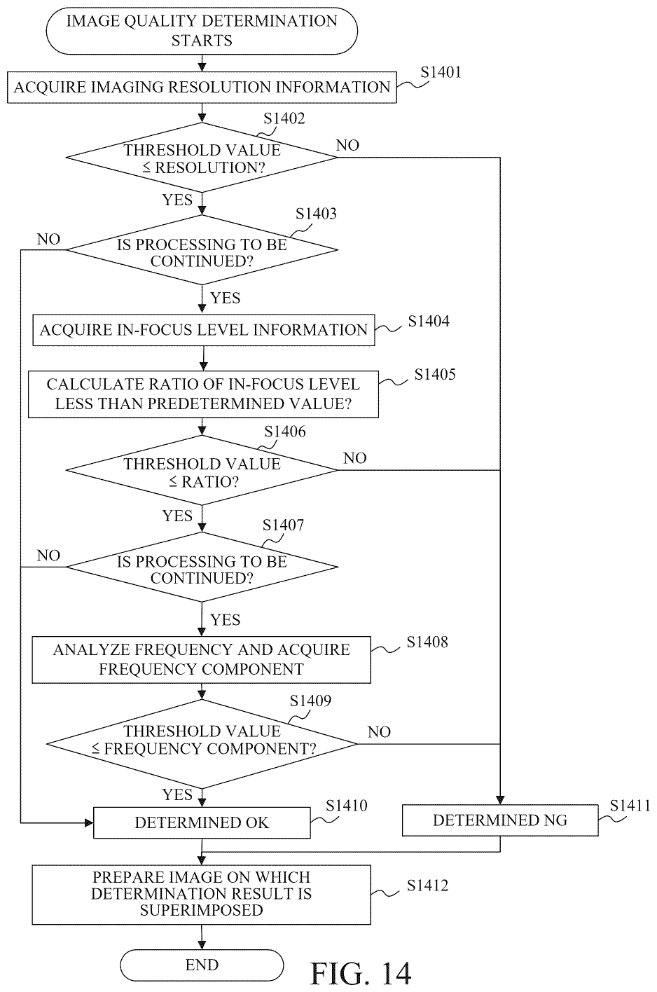

As illustrated in FIG. 13, an image 1301 to be re-captured and an image 1302 to be re-captured in a combined image 450 are displayed on the display unit 105. In the example of FIG. 13, the imaging position or imaging range that needs to be re-imaged is highlighted on the combined image to present it to the user, but another form is also applicable. For example, the imaging position or imaging direction that needs to be re-captured may be output as text information. Information that can specify the captured image that needs to be re-captured may be stored in a specified folder in the apparatus. Information for specifying the presence of an image that is not to be used for image processing such as abnormality detection or combination or the need for re-capturing may be output as a display or sound.

Information indicating the determination result in step S205 may be associated with each of the images that are the targets of the determination and output. For example, information indicating that the image can/cannot be used for image processing such as abnormality detection or combination, or that re-capturing is/is not necessary, may be associated with each of the images that are the targets of determination and output. The information “OK” indicating that the image quality satisfies the condition, or the information “NG” indicating that the image quality does not satisfy the condition may be associated with each of the images to be determined and output. Thus, the information on whether or not an image is to be used for the predetermined image processing may be output in various ways.

Referring now to FIG. 3, a detailed description will be given of step S201 (imaging processing) in FIG. 2. FIG. 3 is a flowchart illustrating the imaging processing.

First, in step S301, the information processing apparatus 100 accepts a user designation of an inspection range (imaging range) in a structure. The information processing apparatus 100 determines the number of captured images and their respective imaging positions based on the area of the designated inspection range (imaging range). For example, the information processing apparatus 100 accepts a user designation that the imaging area 400 in FIG. 4A is the inspection range (imaging range). The information processing apparatus 100 calculates the number of images to be captured and their respective imaging positions based on two diagonal points on the imaging area 400. For example, in a case where the inspection target of a structure is 7 m wide×3 m high, and the range that can be captured with a single captured image is Im wide×Im high, it is determined that 21 captured images of 7 columns×3 rows are required, as illustrated in FIG. 4B.

In a case where the user has completed the designation of the inspection range (imaging range), in step S302, the CPU 101 creates a captured image list illustrated in table 501 in FIG. 5A based on the number of captured images and the imaging positions calculated in step S301. In FIG. 5A, the table 501 is a table representing a captured image list. The table 501 includes a captured image ID, imaging position, captured image file name, and determination information. The attributes included in the table 501 are illustrative, and it is not necessary that all of them are essential, and the configuration may include another attribute. The captured image ID is an ID for identifying a captured image file. The imaging position represents an imaging position used by the camera platform device, and for example, the upper left is stored in the form of coordinates such as “row 1, column 1”. The determination information stores a determination result in the image-quality determining processing in step S205. At the stage when the table 501 is created in step S302, as illustrated in FIG. 5A, the imaging ID and imaging position information calculated from the number of shots are entered, and the captured image file name and determination information fields are left blank.

Next, in step S303, the CPU 101 controls the camera platform device, which is the imaging assisting apparatus 150, and image pickup apparatus 180, to perform imaging in the order of the captured image IDs in the table 501 created in step S302, based on the imaging position information corresponding to the captured image ID.

The information processing apparatus 100 changes the imaging direction and imaging position of the imaging assisting apparatus 150 for each captured image ID, based on coordinate information entered in the imaging position information in the table 501. The information processing apparatus 100 then controls the image pickup apparatus 180, for example, for focusing using an autofocus (AF) function that uses the center of the screen as the focal point. The information processing apparatus 100 sends an imaging instruction to the image pickup apparatus 180 so that imaging is performed as the AF is completed. According to the control of the imaging assisting apparatus 150 or an imaging completion notification sent from the image pickup apparatus 180, the information processing apparatus 100 writes information such as the captured image file name in the record of the captured image list in the captured image file name field in the table 501 as illustrated in FIG. 5B. The information processing apparatus 100 repeats this processing until imaging of images corresponding to the captured image list is completed. In a case where imaging of all images corresponding to the created captured image list is completed, the imaging processing ends.

Referring now to FIG. 6, a detailed description will be given of step S203 (imaging-condition determining processing) in FIG. 2. FIG. 6 is a flowchart illustrating the imaging-condition determining processing.

First, in step S601, the CPU 101 acquires imaging information (values regarding imaging information) included in the captured image to be processed. The imaging information is metadata recorded as imaging parameters that were used during capturing of the image, and includes, for example, the time during imaging, the aperture value (F-number), or the ISO speed, but is not limited to them.

Next, in step S602, the CPU 101 determines whether or not a value regarding the imaging information acquired in step S601 matches the predetermined imaging condition. In a case where it is determined that the value regarding the imaging information is out of the imaging condition (Yes), the flow proceeds to step S603. On the other hand, in a case where it is determined that the value regarding the imaging information is within the imaging condition (No), the flow ends. The imaging condition is a condition regarding whether or not the value regarding the imaging information is within the threshold or range, which have been previously set. For example, the imaging condition may use an aperture value, ISO speed, or object distance, as described in the processing description of step S203.

In step S603, in a case where the determination result of step S602 is out of the imaging condition, the CPU 101 determines the determination result as outside the imaging condition and records it in the determination information field of the table 501. In a case where the value of the acquired imaging information meets the predetermined imaging condition, this fact may be recorded in the determination information field in the table 501.

Referring now to FIG. 7, a detailed description will be given of step S205 (image-quality determining processing) of FIG. 2. FIG. 7 is a flowchart illustrating the image-quality determining processing according to this example.

First, in step S701, the CPU 101 (converter 101a) performs frequency analysis processing for the captured image and obtains a frequency component (first frequency characteristic, first frequency characteristic data). That is, the converter 101a converts a captured image into first frequency characteristic data. This example calculates horizontal and vertical frequency components using a wavelet transform as an example of frequency analysis processing. Both camera blur in the horizontal direction (horizontal camera blur) and camera blur in the vertical direction (vertical camera blur) can be determined by obtaining the frequency component in the horizontal direction and the frequency component in the vertical direction.

It is not essential to obtain both horizontal and vertical frequency components, and only one of them may be obtained. Also, the frequency component in the diagonal direction may be obtained to perform camera blur determination. In addition, a first feature amount obtained by performing normalizing processing, thresholding processing, or the like for the first frequency characteristic data obtained by performing a wavelet transform or Fourier transform for a captured image may be used. The processing content is not limited to normalizing processing or thresholding processing.

In this example, the frequency analysis processing is not limited to the processing of acquiring a frequency component using a wavelet transform, and the frequency component may be acquired using a Fourier transform. This example acquires a frequency characteristic of the entire captured image, but is not limited to this implementation, and a frequency characteristic of only a part of the captured image may be acquired. For example, a frequency characteristic of the central 50% area of the captured image may be acquired. Thereby, the processing time of the wavelet transform can be reduced.

Next, in step S702, the CPU 101 acquires in-focus level information contained in an image to be processed (captured image). The in-focus level information in this example is information acquired together with an image captured by the image pickup apparatus 180 having an entire image-plane phase-difference imaging sensor, and is information in which a defocus amount for each area in the image is recorded.

FIGS. 8A and 8B are examples of a defocus map that is in-focus level information. An outer frame 801 and an outer frame 821 are frames corresponding to the image size of an input image. Numerical values 802 and 822 are defocus amounts indicating the in-focus level in each area. Lines 803 and 823 indicate boundaries between areas with different defocus amounts. Here, the defocus value is a numerical representation of a shift amount from a focus position in forward and backward directions for each pixel in an image relative to an object. The sign of the defocus amount may be changed in a case where the focus is shifted forward and backward in the depth direction. That is, for example, a defocus amount may be positive in a case where the focus is shifted forward and negative in a case where the focus is shifted backward.

An image-plane phase-difference imaging sensor disposed on the entire surface of the sensor (image sensor) of the image pickup apparatus 180 during imaging can provide defocus amount information at a position of a pixel that can be obtained. A known technology can be used to obtain defocus value information. The defocus value may be obtained using a parallax image captured by a stereoscopic camera or the like.

In the defocus maps of FIGS. 8A and 8B, an area with a defocus amount (value) of “0” is an in-focus area in the focus unit of the image pickup apparatus 180. In areas having defocus amounts larger than “0,” as a defocus amount increases, the in-focus level decreases or a focus shift amount from a distance at which the optical system is in focus increases. The example of FIG. 8A illustrates two defocus amounts, i.e., “0” and “1” and the example of FIG. 8B illustrates three defocus amounts, i.e., “0”, “1”, and “2,” but the number of defocus amounts is not limited.

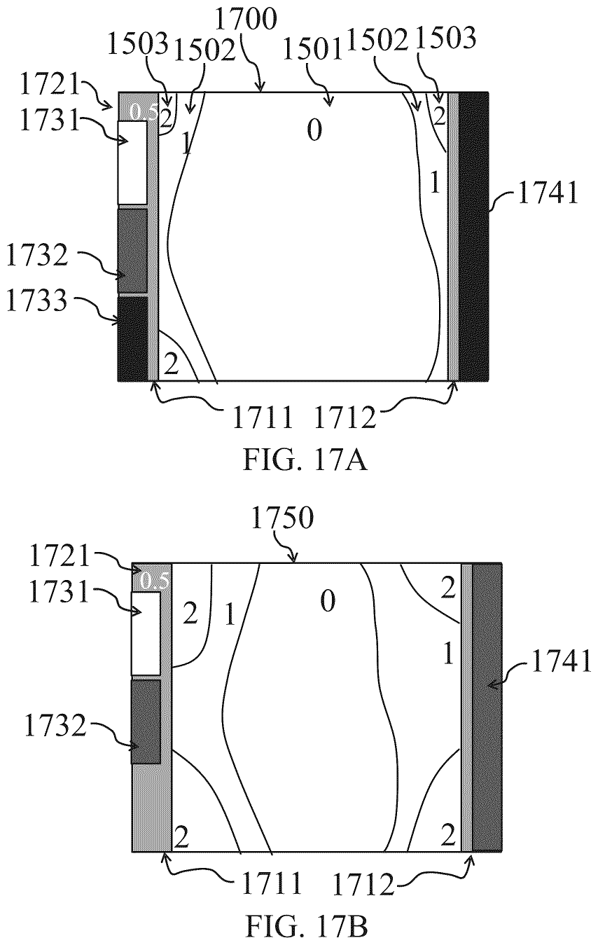

Next, in step S703, the CPU 101 acquires abnormal luminance information of the captured image. The abnormal luminance information is information indicating a luminance saturation area or a black crush area of the captured image. The luminance saturation area and the black crush area are each a low contrast area. Such an area has many low frequency components even if no camera blur occurs during imaging. Therefore, it may be determined that camera blur occurs even if no camera blur occurs. Hence, in step S703, the abnormal luminance area is specified and excluded from the first frequency characteristic data. For example, in a case where the captured image is a developed image with luminance values of 0 to 255, the abnormal luminance area can be specified by setting an average luminance value of the entire captured image as a reference value and any value outside the range of −20 to +20 from the reference value as the abnormal luminance value. The method of setting the range from the reference value will be described later using a setting screen 1601 in FIG. 16.

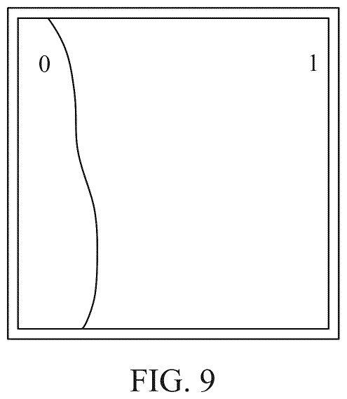

In a case where a luminance saturation area (with a luminance value of 255) exists, the average luminance value of the inspection target area cannot be correctly obtained. For this reason, the average luminance value may be obtained (calculated) from an area obtained by excluding the luminance saturation area from the captured image. It is not essential to use the average luminance value as the reference value, and the reference value may be previously set. FIG. 9 is an example of an abnormal luminance map as abnormal luminance information in a captured image having the defocus map of FIG. 8A. In the abnormal luminance map illustrated in FIG. 9, an area labelled as “0” is an area (abnormal luminance area) that is farther away from the average luminance value of the captured image by more than the reference value. The order of steps S702 and S703 may be reversed, and the abnormal luminance map may be obtained before the defocus map.

Next, in step S704 in FIG. 7, the CPU 101 (the generator 101b) excludes a predetermined area from the first frequency characteristic (first frequency characteristic data) and acquires the second frequency characteristic (second frequency characteristic data). That is, the generator 101b generates the second frequency characteristic data by excluding the data of the predetermined area from the first frequency characteristic data.

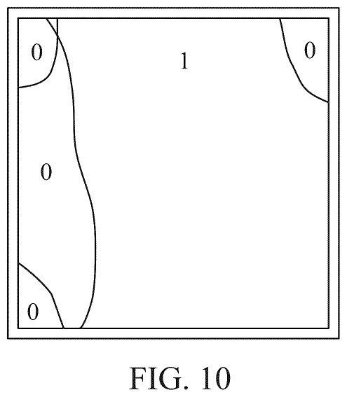

Thus, the CPU 101 first generates an exclusion map having “0” in the defocus area and the abnormal luminance area and “1” in other areas based on the defocus map and the abnormal luminance map, and multiplies the first frequency characteristic by this exclusion map. FIG. 10 is an example of the exclusion map generated based on the defocus map in FIG. 8A and the abnormal luminance map in FIG. 9. It is not essential to generate an exclusion map, and as long as the defocus area and the abnormal luminance area may be removed, the processing method is not limited. A reference value (statistic) described later can be accurately determined by previously removing the defocus area and the abnormal luminance area from the first frequency characteristic.

In a case where the majority of the captured image is a defocus area and an abnormal luminance area, a peak appears on a low frequency side of the peak frequency of the inspection target, such as a concrete wall surface. In a case where this peak is used as a reference value and an area outside the predetermined range is excluded, the concrete wall surface of the inspection target will be excluded. In other words, the area of the captured image for which the reference value is calculated is determined based on whether or not a feature amount (second feature amount) based on distance information falls within a predetermined range (predetermined second range) based on distance information on the focal plane of the captured image. In this example, the area labeled as “0” in the defocus map of FIG. 8A corresponds to the predetermined second range. In a case where the defocus map has a normalized value such as 0 to 1, for example, an area having a value from 0 to 0.2 may be set as the predetermined second range.

The area of the captured image for which the reference value is calculated is determined based on whether or not a feature amount based on a luminance value (third feature amount) falls within a predetermined range (predetermined third range) based on the average luminance value of the captured image. The predetermined range in this example refers to a range of −20 to +20 from the reference value by setting the average luminance value of the entire captured image as the reference value. In the abnormal luminance map illustrated in FIG. 9, the area labeled as “1” corresponds to it.

The CPU 101 then divides the first frequency characteristic, from which the defocused area and the abnormal luminance area are excluded, into vertical 100×horizontal 150 areas, and calculates the average value (average wavelet value) for each area. The number of divided areas is not limited, and the average value can be calculated from any number of divisions. Instead of the average value, the mode or median may be used. Next, an outlier area is obtained based on the average value for each area. An outlier area is an area out of the predetermined range from the reference value in the first frequency characteristic, from which the defocused area and the abnormal luminance area are excluded.

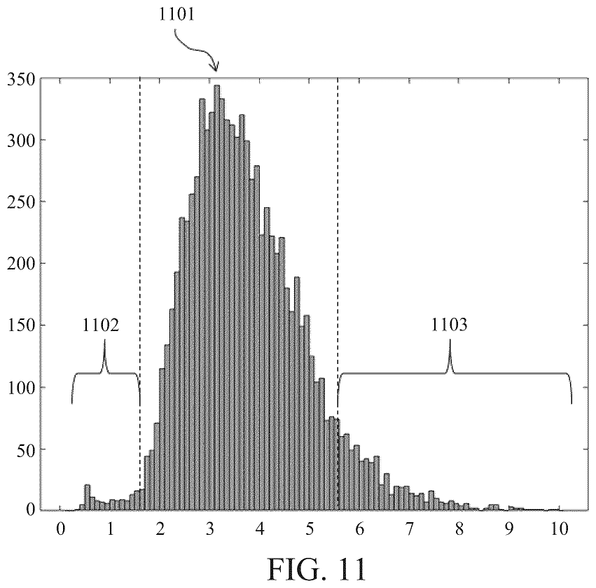

FIG. 11 is an example of a histogram display of the average wavelet value for each area. This example sets a mode 1101 of the average wavelet value for each area as a reference value, and a predetermined range to −2.0 to +2.0 from the reference value. Thus, the reference value is a statistic based on the first frequency characteristic data of the captured image, that is, a statistic of the first feature amount regarding the first frequency characteristic data (at least one of the average value, the median value, and the mode value). A method for setting the predetermined range from the reference value will be described later with reference to the setting screen 1601 in FIG. 16. This example uses a statistic based on a single captured image, but the statistic may be based on a plurality of captured images captured in step S201. It is not essential to use the mode value as the reference value, and another representative value such as an average value or a median value may be used. A numerical value from the reference value that defines the predetermined range is not limited to −2.0 to +2.0.

By statistically determining the reference value based on the captured image, the inspection target is not limited to a concrete wall surface, and foreign objects in the inspection target having various frequency distributions can be excluded. In a case where the inspection target is a concrete wall surface, there may be exposed reinforcing bars, piping, or dirt in the captured image. Exposed reinforcing bars have more high-frequency components, and piping and dirt have more low-frequency components than those of the concrete wall surface. Therefore, in a case where a reference value that is determined regardless of the inspection target is used, this will cause a decrease in the camera-blur determining accuracy. In the histogram illustrated in FIG. 11, an area 1102 corresponds to pipes and dirt, and an area 1103 corresponds to exposed reinforcing bars. The blur determining accuracy can be improved by determination using an area from which the pipes, dirt, and exposed reinforcing bars are excluded.

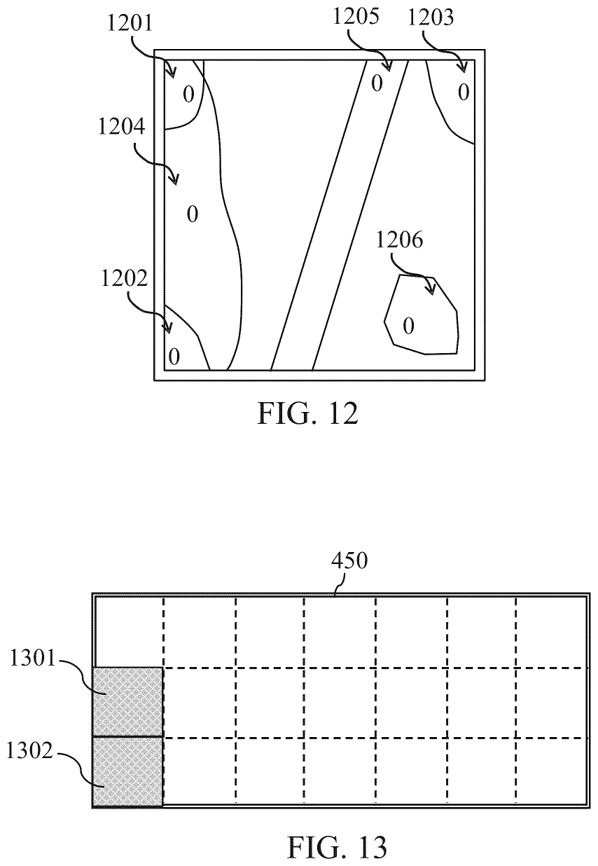

FIG. 12 is an exclusion map illustrating areas that are finally excluded from the first frequency characteristic. Areas labeled as “0” are excluded, reference numerals 1201 to 1203 denote defocus areas, reference numeral 1204 denotes an abnormal luminance area, and reference numerals 1205 to 1206 denote outlier areas in the frequency characteristic (1205: pipes, 1206: exposed reinforcing bars). Based on this exclusion map, the CPU 101 generates the second frequency characteristic from the first frequency characteristic.

In this example, the predetermined area to be excluded from the first frequency characteristic may include at least one of the defocused area, the abnormal luminance area, and the outlier area. The predetermined area is determined according to whether the first feature amount regarding the first frequency characteristic data falls within a predetermined range (predetermined first range) based on the statistic of the first feature amount. For example, the predetermined area is an area where the first feature amount is outside the predetermined first range (an area that does not fall within the predetermined range based on the statistic obtained based on the first frequency characteristic data). In a case where the frequency characteristic is acquired after the excluded map is multiplied by the captured image, the boundary with the excluded area becomes an edge, and high-frequency components that do not actually exist are generated. Thus, the excluded map may be multiplied by the first frequency characteristic.

Next, in step S705 of FIG. 7, the CPU 101 analyzes the frequency components of the second frequency characteristic and calculates an average value. The average value is not essential, and a mode or median value may be calculated.

Next, in step S706, the CPU 101 determines whether or not the average value (frequency component) calculated in step S705 is equal to or larger than a predetermined threshold value. In a case where the frequency component is equal to or larger than the predetermined threshold value (Yes), the flow proceeds to step S707. On the other hand, in a case where the frequency component is smaller than the predetermined threshold value (No), the flow proceeds to step S708.

In step S707, the CPU 101 determines that re-capture is not necessary (OK) as a result of the image quality determination of the captured image, records the determination result in the determination information field of the table 501, and ends the image-quality determining processing. At this time, the CPU 101 may use the captured image file to be processed for image processing such as abnormality detection or combination.

In step S708, the CPU 101 determines that re-capture is necessary (NG) as a result of the image quality determination of the captured image, records the determination result in the determination information field of the table 501, and completes the image-quality determining processing. At this time, the CPU 101 determines that the captured image file to be processed is not to be used for image processing such as abnormality detection or combination.

Thus, in steps S704 to S708, the CPU 101 (determining unit 101c) determines whether or not the captured image is blurred based on the second frequency characteristic data. Here, the blur of the captured image includes (defocus) blur caused by the captured image that is not in focus on the object or (camera) blur caused by the movement of the image pickup apparatus during exposure, but is not limited to them.

The image-quality determining processing in step S205 is an example using a frequency characteristic, but the image quality may be determined using the result of other image processing. For example, the image quality may be determined based on in-focus level information, that is, the in-focus level or the imaging resolution. Also, information indicating camera blur, information on the in-focus level, and information on the imaging resolution may be combined. In other words, the result of image quality determination using in-focus level information, the result of image quality determination using the camera blur degree based on frequency analysis processing, and the imaging resolution may be used to determine whether or not re-capturing is necessary within the imaging range of the captured image.

In this example, the imaging processing in step S201 is performed by control of the information processing apparatus 100, but this is not limited. That is, the information processing apparatus 100 may omit the processing of step S201, and may acquire information necessary for the subsequent processing, such as a captured image list, in acquiring a captured image in step S202.

### Example 2

A description will now be given of an information processing system according to Example 2 of the present disclosure. In Example 1, the frequency characteristic is used for the image-quality determining processing. As described above, the image quality may be determined based on in-focus level information, that is, the focus degree, or the imaging resolution. In this example, the image-quality determining processing is performed by combining the camera blur determination using the frequency characteristic, information on the in-focus level, and the information on the imaging resolution. This example is similar to Example 1 except for the image-quality determining processing, and thus a description common to Example 1 will be omitted.

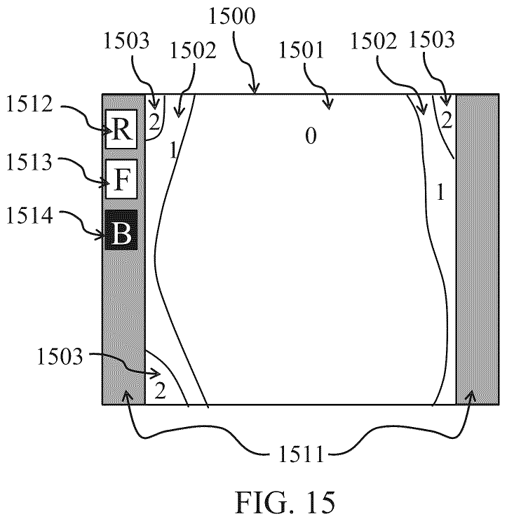

Referring now to FIG. 14, a description will be given of the image-quality determining processing according to this example. FIG. 14 is a flowchart illustrating the image-quality determining processing according to this example.

First, in step S1401, the CPU 101 acquires the imaging resolution information included in the captured image. More specifically, the CPU 101 calculates the imaging resolution based on the image size of the captured image, the size of the imaging sensor, and a distance from the imaging surface. The distance from the imaging surface is obtained by acquiring a distance to an object during focusing at a position of a focus measuring point of the object.

Next, in step S1402, the CPU 101 determines whether the imaging resolution acquired in step S1401 is equal to or larger than a predetermined threshold value. In a case where the imaging resolution is equal to or larger than the predetermined threshold value (Yes), the flow proceeds to step S1403. On the other hand, in a case where the imaging resolution is smaller than the predetermined threshold value (No), the flow proceeds to step S1411. Thereby, whether the imaging resolution required for the quality of the inspection image is satisfied can be determined. In a case where the imaging resolution is smaller than the threshold value, that is, in a case where the object is roughly imaged, the result may be determined to be “NG” without carrying out the subsequent determination processing. The setting of the threshold value for determining the imaging resolution will be described later with reference to the setting screen 1601 in FIG. 16.

In step S1403, the CPU 101 determines whether to continue the processing after the imaging resolution determination. In a case where the processing is to be continued (Yes), the flow proceeds to step S1404. On the other hand, in a case where the processing is to be ended, the flow proceeds to step S1410. The setting of whether or not to continue the processing after the imaging resolution determination will be described later with reference to the setting screen 1601 in FIG. 16.

In step S1404, the CPU 101 acquires in-focus level information contained in the image to be processed. The acquiring method is processing similar to that described in Example 1, and thus a description thereof will be omitted.

Next, in step S1405, the CPU 101 calculates a ratio of the in-focus area (ratio of the in-focus level less than a predetermined value) using the in-focus level information acquired in step S1404. Referring now to FIG. 8A, a description will be given of the calculation of the ratio of the in-focus area. The ratio of the in-focus area in the image is calculated by using the number of pixels enclosed by the outer frame 801 as the denominator and the number of pixels with a defocus value of “0” as the numerator. In the example illustrated in FIG. 8A, the ratio of the defocus amount “0” is about 90%. In the example illustrated in FIG. 8B, the ratio of the defocus amount “0” is about 60%.

Next, in step S1406, the CPU 101 determines whether the ratio calculated in step S1405 is equal to or larger than a predetermined threshold value. In a case where the ratio is equal to or greater than the predetermined threshold value (Yes), the flow proceeds to step S1407. On the other hand, in a case where the ratio is smaller than the predetermined threshold value (No), the flow proceeds to step S1411. In a case where the threshold value for the ratio is 80%, the ratio is equal to or larger than the threshold value (80%) in FIG. 8A, and is smaller than the threshold value (80%) in FIG. 8B. The threshold value has been described as 80%, but it may be arbitrarily set based on a user input. The threshold value may be determined based on a relationship between the ratio of the in-focus area and the detection accuracy of detecting abnormalities. For example, various methods may be adopted, such as previously setting a ratio at which the average accuracy of detecting abnormalities is 95% or more as the threshold value.

In step S1405, the ratio of the area where the defocus amount is “0” is calculated, but this is not limited to this example. For example, a ratio of an area where the defocus amount is “0” or “1” may be calculated. In other words, an area where the in-focus level is equal to or larger than a threshold value may be calculated. Also, in step S1405, a ratio of an area where a defocus amount is “3” may be calculated, and the flow may proceed to step S1407 in a case where the ratio is smaller than a threshold value in step S1406, and the flow may proceed to step S1411 in a case where the ratio is larger than the threshold value. Also, in step S1405, a first ratio of an area where a defocus amount is “0” and a second ratio of an area where a defocus amount is “3” may be calculated. In this case, the flow may proceed to step S1407 in a case where the first ratio is larger than a first threshold value and the second ratio is smaller than a second threshold value different from the first threshold value, and otherwise the flow may proceed to step S1411.

Thus, it is possible to determine whether the in-focus level of the image satisfies various predetermined conditions based on the in-focus level information, and to determine whether the image is to be used for image processing such as abnormality detection and combination according to the result of the in-focus state determination. Also, it may be determined whether the in-focus level of the image satisfies various predetermined conditions based on the in-focus level information, and to determine whether or not re-capturing is necessary according to the result of the in-focus state determination.

In step S1407, the CPU 101 determines whether or not to continue processing after the in-focus level determining processing. In a case where the processing is to be continued (Yes), the flow proceeds to step S1408. On the other hand, in a case where the processing is to be ended (No), the flow proceeds to step S1410. Similarly to step S1403, the setting of whether or not to continue processing will be explained using the setting screen 1601 in FIG. 16, which will be described later.

In step S1408, CPU 101 performs frequency analysis processing for the captured image and obtains a frequency component. The frequency analysis processing is omitted because it is similar to that of Example 1.

Next, in step S1409, CPU 101 determines whether the frequency component calculated in step S1408 is equal to or larger than a predetermined threshold value. In a case where the frequency component is equal to or larger than the threshold value (Yes), the flow proceeds to step S1410. On the other hand, in a case where the frequency component is smaller than the threshold value (No), the flow proceeds to step S1411. Thereby, in a case where the frequency component value is larger than the threshold value, it is determined that there are many high frequency components and many areas including edges. In a case where the frequency component value is smaller than the threshold value, it is determined that there are many low frequency components and that the influence of camera blur is large. By performing camera-blur determining processing after the in-focus level determination, it can be determined whether an image is suitable for an inspection image even in an imaging situation where it is determined that the image is in focus but camera blur occurs. An example of a situation where the image is in focus but camera blur occurs is a situation where the image was captured while the camera is mounted on an aircraft such as a drone, and it is assumed that the drone shakes due to the influence of wind during imaging. A threshold value for the camera blur determination will be described using the setting screen 1601 in FIG. 16, which will be described later.

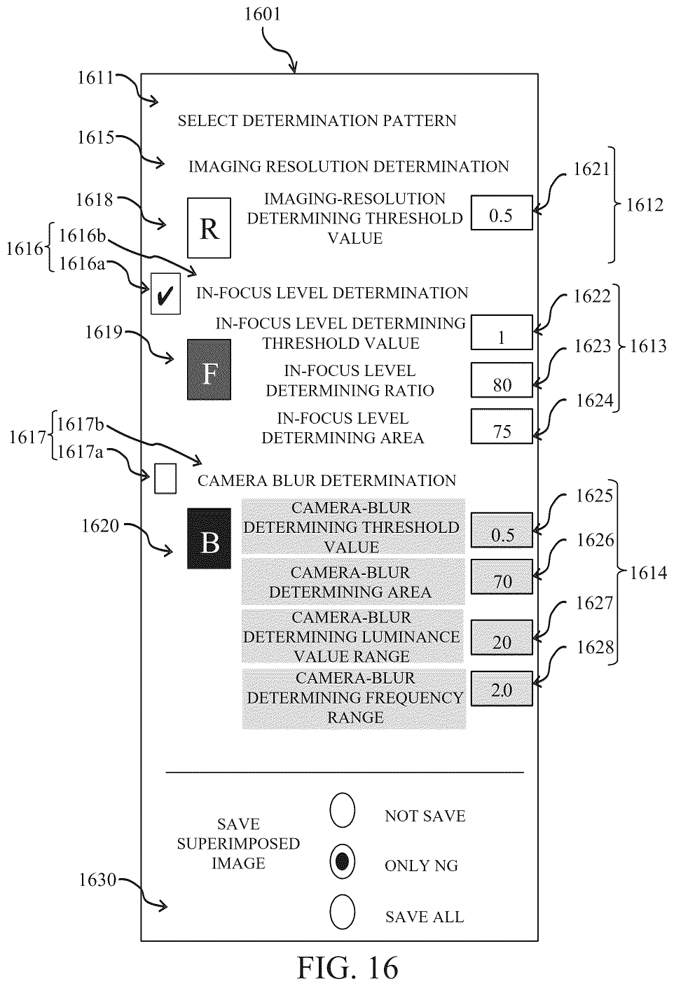

Next, in step S1412, the CPU 101 generates an image on which the determination result is superimposed using information on the result determined in step S1407 or S1411. Referring now to FIG. 15, a description will be given of the image generated in step S1512. FIG. 15 explains a defocus map. A resultant image 1500 includes a defocus area 1501, a defocus area 1502, a defocus area 1503, and a frame area 1511. The frame area 1511 has an imaging-resolution determining area 1512, an in-focus level determining area 1513, and a camera-blur determining area 1514.

The defocus areas 1501, 1502, and 1503 are areas obtained by dividing the defocus map illustrated in FIG. 8B for each defocus amount, and the area with a defocus amount of 0 is represented by the defocus area 1501. The area with a defocus amount of 1 is represented by the defocus area 1502, and the area with a defocus amount of 2 is represented by the defocus area 1503, and areas with the same defocus amount are treated as the same defocus area. A colored layer is generated for each defocus area, and the colored layers are superimposed on the captured image. The color to be applied to the layer may be, for example, a warning color, and blue or green may be used as a color indicating high safety in a case where the defocus amount is smaller than a predetermined value, and yellow or red may be used as a color indicating high alertness when the defocus amount is larger than a predetermined value. Thereby, the user can easily visually recognize areas that have large defocus amounts and require re-capturing.

In the frame area 1511, an imaging-resolution determining area (imaging-resolution determining icon) 1512, an in-focus level determining area (focus-level determining icon) 1513, and a camera-blur determining area (camera-blur determining icon) 1514 are displayed as marks indicating each determination result. The resultant image 1500 illustrates an example in which the imaging resolution determination and in-focus level determination are OK, but the camera-blur determination is NG (no good), and changes the expression depending on the result. As an example of the icon expression, the imaging-resolution determining area 1512 and in-focus level determining area 1513 that are determined to be OK are represented by black characters with white background, and the camera-blur determining area 1514 that is determined to be NG is represented by a white character with black background.

Thereby, the user can visually recognize the determination result, and easily confirm at what stage an error occurred. A configuration may be employed which enables the user to confirm which determination method was not executed by the presence or absence of an icon. For example, assume that the CPU 101 determines in step S1402 in FIG. 14 that the imaging resolution acquired in step S1401 is equal to or lower than a predetermined threshold value. In this case, only the imaging-resolution determining area 1512 may be displayed in the frame area 1511 of the resultant image 1500, and both the in-focus level determining area 1513 and camera-blur determining area 1514 may not be displayed.

The color of each icon may be changed in the frame area 1511 based on the determination result. For example, red may be assigned to the imaging resolution determination, blue to the in-focus level determination, and yellow to the camera-blur determination. In a case where an image is determined to be NG in the in-focus level determination, an image is created in which the frame area is filled with blue. Thereby, it possible to distinguish determination results that are difficult to distinguish from the icons in the determination area, by coloring the frame area, even in small image sizes such as thumbnail images. This concludes the description of the flowchart in FIG. 14.

FIG. 16 illustrates the setting screen 1601 as an example of a UI screen for setting parameters in this example. The setting screen 1601 includes a determination pattern selector 1611 and a selector 1630 for selecting a superimposed image saving (storing) condition. The determination pattern selector 1611 is divided into three sections: an imaging-resolution determining section 1612, an in-focus level determining section 1613, and a camera-blur determining section 1614. Each determining section has determining name labels 1615, 1616, 1617, and determining symbols 1618, 1619, and 1620, respectively.

In addition, input areas 1621 to 1628 for numerical values such as determination threshold values for the flowchart of FIG. 14 are placed in 1612 to 1614, respectively, corresponding to the determination processing that use them. More specifically, the imaging-resolution determining section 1612 has a determination name label 1615 of the imaging resolution, a determination symbol 1618 of the imaging resolution, and an input area 1621 for an imaging-resolution determining threshold value. In the in-focus level determining section 1613, an in-focus level determining name label 1616, an in-focus level determining symbol 1619, an input area 1622 for an in-focus level determination threshold value, an input area 1623 for an in-focus level determining ratio, and an input area 1624 for an in-focus level determining area are placed. The camera-blur determining section 1614 includes a camera-blur determining name label 1617, a camera-blur determining symbol 1620, an input area 1625 for a camera-blur determining threshold value, an input area 1626 for a camera-blur determining area, a camera-blur determining luminance range 1627, and a camera-blur determining frequency range 1628. Due to this arrangement, the user can intuitively recognize which determination processing each value relates to.

By matching the shapes of the icons (1512, 1513, 1514) in FIG. 15 with the determination symbols 1618, 1619, and 1620, respectively, the user can intuitively recognize a relationship between the determination settings made on this screen and the results, on the resultant superimposed image. Of course, these icons and determination symbols may have different designs. The setting screen 1601 is a screen displayed on a personal computer (PC), smartphone, tablet terminal, etc. A user can turn on and off checkboxes and radio buttons, which will be described later, and input numerical values by using a mouse, touch operation, keyboard operation, etc. (using the operation unit 106).

Among the determination name labels, the in-focus level determining name label 1616 includes an in-focus level determining checkbox 1616a and an in-focus level determining name section 1616b. The camera-blur determining name label 1617 includes a camera-blur determining checkbox 1617a and a camera-blur determining name section 1617b. Turning on and off these checkboxes can specify whether to further perform the corresponding determination processing in a case where the result of the imaging resolution determination, which is always performed, is OK. For example, in FIG. 16, the in-focus level determining checkbox 1616a is turned on and the camera-blur determining checkbox 1617a is turned off, which indicates that in a case where the result of the imaging resolution determination is OK, the in-focus level determination continues and camera blur determination is not performed.

In FIG. 16, the in-focus level determining checkbox 1616a is turned on, so the input areas 1622 to 1624 are available for input. In addition, the camera-blur determining checkbox 1617a is turned off, so the input areas 1625 and 1626 are grayed out, indicating that input is not available. Thereby, the user can focus only on inputting values relating to the determination.

The CPU 101 determines whether to continue processing in steps S1403 and S1407 based on the states of the in-focus level determining checkbox 1616a and the camera-blur determining checkbox 1617a. This configuration can omit the subsequent processing in situations where the subsequent processing is not necessary, even if the previous determination is determined to be OK. For example, in the case of an imaging mode using a drone, which is likely to generate camera blur, the camera-blur determining checkbox 1617a can be turned on to perform camera blur determination. On the other hand, in the case of an imaging mode using a tripod, which is less likely to generate camera blur, the camera-blur determining checkbox 1617a can be turned off to prohibit camera blur determination. In addition, when only the imaging resolution determination is performed, the imaging resolution can be identified and it can be confirmed whether an image matching the inspection image has been captured by turning off the in-focus level determining checkbox 1616a and the camera-blur determining checkbox 1617a. In the determination processing on a large number of images, the processing can be terminated according to the application or purpose, and the effect of reducing the processing time as described above can be expected.

A value input to the imaging-resolution determining threshold-value input area (first setter) 1621 represents the threshold value in step S1402. A value input to the input area 1622 for the in-focus level determining threshold value represents the predetermined value in step S1405. A value input to the in-focus level determining ratio input area (second setter) 1623 represents the threshold value for the ratio in step S1406. A value input to the in-focus level determining area input area (second setter) 1624 is an item for setting the area for calculating the ratio in step S1405, and represents the area percentage of the central area to be determined in a case where the area of the entire determination processing target image is set to 100%. By reducing the central area to be determined (narrowing the area), a calculation processing amount is reduced, and speed improvement is expected. By setting an area to be determined to an arbitrary value less than 100% (e.g., 50%) using the value input to the in-focus level determining area input area (second setter) 1624, only the central portion of the image to be applied to the combined image is determined in creating a stitched combined image. By determining only the central portion, the outer periphery of the image that will be a sticking tab is excluded from the determination. This configuration can determine that the image can be used for stitching combination even if the outer periphery is out of focus.

A value input to the input area (third setter) 1625 for the camera-blur determining threshold value represents the threshold value in step S1409. A value input to the camera-blur determining area input area (third setter) 1626 is an item for setting an area for calculating a frequency component value in step S1408. This value represents the area percentage of the central area to be calculated in a case where the area of the entire image to be calculated is set to 100%. A similar effect to that of the in-focus level determining area can be obtained.

A value input to the camera-blur determining luminance range 1627 is used to exclude an abnormal luminance area in steps S703 and S1408. For example, in a case where the value is 20, the area outside the range of −20 to +20 from the reference value becomes the abnormal luminance area. A value input to the camera-blur determining frequency range 1628 is used to exclude an outlier area in steps S704 and S1408. For example, in a case where the value is 2.0, the area outside the range of −2.0 to +2.0 from the reference value is excluded from the camera-blur determining area.

In this example, the image-quality determining processing in step S205 is replaced with the flowchart illustrated in FIG. 14, and the imaging resolution determination is performed before the in-focus level determination, and the camera-blur determining processing is performed after the in-focus level determination. Due to the imaging resolution determination, it is possible to determine whether imaging is suitable for imaging of an inspection image, and the processing time can be reduced, and a large number of images can be determined in a short time. By performing the camera blur determination, the influence of camera blur can be determined in the case of imaging using a drone, where camera blur occurs even if an in-focus state is determined. The processing time can be reduced according to the imaging environment by selecting whether or not to execute each determination processing or in a case where NG is determined in the determination processing.

In this example, as illustrated in FIG. 14, the imaging resolution determination, the in-focus level determination, and the camera-blur determination are performed in this order, but any order may be used. However, by performing the processing in the order illustrated in FIG. 14, the following effects can be obtained. By performing the imaging resolution determination first, it is possible to determine whether to continue or end the processing according to whether the imaging resolution of the image is suitable for inspection. By performing the camera-blur determination processing last, whether an image that is in focus but has camera blur can be determined. By providing the frequency analysis processing that takes a long time at the last stage, the number of executions of the frequency analysis processing can be reduced according to the determination results of the previous stage, and the overall processing time can be reduced.

In the screen (display) of FIG. 16, due to the order of the imaging-resolution determining section 1612, the in-focus level determining section 1613, and the camera-blur determining section 1614, the user can intuitively understand that these three determination processes are performed in this order on the setting screen 1601.

The imaging-resolution determining section 1612 has no checkbox such as the in-focus level determining checkbox 1616a and the camera-blur determining checkbox 1617a. This is because if the imaging resolution does not meet the quality required for the inspection image, that is, if the object is roughly imaged, there is no need to perform the subsequent determination processing.

In a case where the camera-blur determining checkbox 1617a is turned on while the in-focus level determining checkbox (first selector) 1616a and the camera-blur determining checkbox (second selector) 1617a are both turned off, the in-focus level determining checkbox 1616a will also be turned on. In a case where the in-focus level determining checkbox 1616a is turned off when both are turned on, the camera-blur determining checkbox 1617a may also be turned off in conjunction.

Thereby, it is possible to ensure that camera blur determination is performed after the in-focus state is determined. This setting configuration that performs the camera-blur determining processing after the in-focus level determination can determine whether the image is suitable for an inspection image, even in an imaging situation where the in-focus state is determined but camera blur occurs.

In the example, a determination result superimposed image is generated regardless of whether the determination result is OK or NG, but a superimposed image may be generated only for targets determined to be NG, or a list of the determination results may be created to shorten the processing time without generating a superimposed image. The selector 1630 of the superimposed image saving condition in FIG. 16 is an example of the selection using radio buttons. In FIG. 16, only “NG” is selected, but “not save” or “save all” may be selected according to the user's operation.

In a case where “not save” is selected in the selector 1630 of the superimposed image saving condition, the determination processing illustrated in FIG. 14 is performed, and images determined to be OK are stored in a predetermined folder, and images determined to be NG are stored in another folder. However, an image on which the image-quality determining result is superimposed as illustrated in FIG. 15 is not created. In a case where only “NG” is selected, the determination processing illustrated in FIG. 14 is performed, and images determined to be OK are stored in a predetermined folder, and images determined to be NG are stored in another folder. In addition, the folder in which the images determined to be NG are stored stores an image on which the image-quality determining result is superimposed as illustrated in FIG. 15. In a case where “save all” is selected, the determination processing illustrated in FIG. 14 is performed, and images determined to be OK are stored in a predetermined folder, and images determined to be NG are stored in another folder. In addition, the folder in which the images determined to be OK are stored stores an image on which the image-quality determining result is superimposed as illustrated in FIG. 15, and the folder in which the images determined to be NG are stored stores an image on which the image-quality determining result is superimposed as illustrated in FIG. 15. Adopting such settings can reduce the processing time while generating only the necessary images according to the user request.

In step S1412, regarding the generation of the determination-result superimposed image, an icon indicating the determination result is superimposed on the resultant image, so that it is possible to know in which processing the determination became NG. Since no icon is displayed for processing for which no determination processing has been performed, it is possible to know to what extent the processing has been performed.

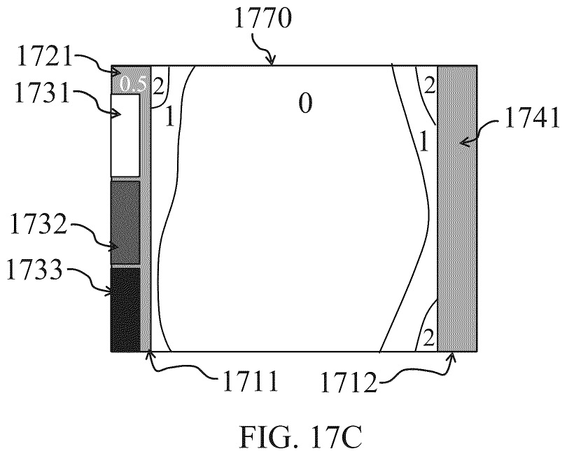

Referring now to FIGS. 17A, 17B, and 17C, a description will be given of examples of other display forms of result-superimposed images. A description of the same reference numerals as those in FIG. 15 will be omitted and only differences will be discussed.

A resultant image 1700 in FIG. 17A is an example where, as a result of performing the imaging resolution determination, in-focus level determination, and camera blur determination, the image has been determined to be NG in the camera-blur determining processing. An imaging-resolution information area 1721, an imaging-resolution determining area 1731, an in-focus level determining area 1732, and a camera-blur determining area 1733 are displayed in the left frame area 1711, and an NG determination area 1741 is displayed in the right frame area 1712. An imaging-resolution information value acquired in step S1401 (0.5 in FIG. 17A) is displayed in the imaging-resolution information area 1721.

In FIG. 17A, three determinations have been made as described above, and therefore an imaging-resolution determining area 1731, an in-focus level determining area 1732, and a camera-blur determining area 1733 are displayed. The imaging-resolution determining area 1731, the in-focus level determining area 1732, and the camera-blur determining area 1733 are each displayed in a different color, and in this example, red is assigned to the imaging-resolution determining area 1731, blue to the in-focus level determining area 1732, and yellow to the camera-blur determining area 1733.

The NG determination area 1741 in the right frame area 1712 displays the same color as that of the determination area corresponding to the determination processing that was NG. In FIG. 17A, the camera-blur determining processing is NG, so the NG determination area 1741 displays the same color as that of the camera-blur determining area 1733.

The resultant image 1750 in FIG. 17B is an example of a case where, as a result of performing the imaging resolution determination and in-focus level determination, the in-focus level determining processing was NG and camera blur determination was not performed. In FIG. 17B, the left frame area 1711 displays the imaging-resolution determining area 1731 and the in-focus level determining area 1732, but does not display the camera-blur determining area 1733. This is because, as described above, the imaging resolution determination and in-focus level determination results in NG in the in-focus level determining processing, and the camera blur determination was not performed. The NG determination area 1741 in the right frame area 1712 displays the same color as that of the in-focus level determining area 1732 corresponding to the in-focus level determination that resulted in the NG determination.

The resultant image 1770 in FIG. 17C is an example of the case where the imaging resolution determination, in-focus level determination, and camera blur determination results in no NG determinations. In FIG. 17C, the imaging-resolution determining area 1731, in-focus level determining area 1732, and camera-blur determining area 1733 are displayed in the left frame area 1711, but the NG determination area 1741 is not displayed in the right frame area 1712.

In a case where the imaging resolution determination is NG, only the imaging-resolution determining area 1731 is displayed in the left frame area 1711, and the NG determination area 1741 in the right frame area 1712 is displayed in the same color as that of the imaging-resolution determining area 1731. In a case where only the in-focus level determining checkbox 1616a is tuned on in the determination pattern selector 1611 and neither the imaging resolution determination nor the in-focus level determination is NG, the imaging-resolution determining area 1731 and the in-focus level determining area 1732 are displayed in the left frame area 1711. On the other hand, nothing is displayed in the NG determination area 1741 in the right frame area 1712.

Due to this UI, the imaging resolution information can be confirmed in the resultant image. In addition, the user can confirm which of the three processes, i.e., the imaging resolution determination, the in-focus level determination, and the camera blur determination was actually performed, and can intuitively confirm which processing was NG. In other words, it is possible to generate visualization information that visualizes which of the imaging resolution determination, in-focus level determination, and camera blur determination was performed, and which of the performed determinations was determined not to satisfy the predetermined condition.

The colors of the imaging-resolution determining area 1731, the in-focus level determining area 1732, and the camera-blur determining area 1733 may correspond to the colors of the determination symbols of the imaging resolution determining symbol 1618, in-focus level determining symbol 1619, and camera-blur determining symbol 1620 in FIG. 16. Thereby, the user can intuitively recognize the relationship between the determination and the result, which has been set by the user, on the result superimposed image.

In this example, an example of an information processing apparatus includes a determining unit having the functions of in-focus level determination, camera blur determination, and imaging resolution determination, and can select a determination mode. However, the determining unit may be configured to have only one or two of these functions. For example, the determining unit may be configured to perform only the imaging resolution determination among the above functions, or may be configured to perform only the in-focus level determination and imaging resolution determination. The configuration of the acquiring unit may correspond to the configuration of the determining unit. Even with such a configuration, the information processing apparatus can determine whether the captured image is to be used for predetermined image processing based on the image quality of the captured image.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an information processing method, image processing apparatus, and storage medium, each of which can determine the blur of a captured image with high accuracy. For example, each example can determine whether or not re-capture is required regardless of the state of an image file, in a case where the image quality of the captured image is poor, such as an image that was not properly in focus during imaging, an image in which camera blur occurred during imaging, or a low-resolution image. Moreover, even in a case where the captured image includes an area that is not subject to inspection, each example can maintain the determination accuracy.

This application claims priority to Japanese Patent Application No. 2023-179303, which was filed on Oct. 18, 2023 and which is hereby incorporated by reference herein in its entirety.

What is claimed is:

1. An information processing method comprising:
a conversion step of converting a captured image into first frequency characteristic data;
a generation step of generating second frequency characteristic data by excluding data of a predetermined area from the first frequency characteristic data; and
a determination step of determining whether or not the captured image is blurred based on the second frequency characteristic data,
wherein in the generation step, the predetermined area is determined according to whether or not the predetermined area falls within a predetermined range based on a statistic obtained based on the first frequency characteristic data.

2. The information processing method according to claim 1, wherein blur of the captured image determined in the determination step includes blur caused by the captured image that is not in focus on an object, and blur caused by movement of an image pickup apparatus during exposure.

3. The information processing method according to claim 1, wherein the statistic is obtained based on a first feature amount that is obtained by performing normalizing processing or thresholding processing for the first frequency characteristic data.

4. The information processing method according to claim 3, wherein the predetermined area is an area in which the first feature amount does not fall within a predetermined range based on the statistic obtained based on the first frequency characteristic data.

5. The information processing method according to claim 1, wherein an area of the captured image for calculating the statistic is determined based on whether or not a feature amount based on distance information of the captured image falls within a predetermined range based on the distance information in a focal plane of the captured image.

6. The information processing method according to claim 1, wherein an area of the captured image for calculating the statistic is determined based on whether or not a feature amount based on a luminance value of the captured image falls within a predetermined range based on an average luminance value of the captured image.

7. The information processing method according to claim 6, wherein the average luminance value is obtained from an area of the captured image, from which a luminance saturated area is excluded.

8. The information processing method according to claim 1, wherein the statistic is at least one of an average value, a median value, and a mode value.

9. The information processing method according to claim 1, wherein the first frequency characteristic data is generated by performing a wavelet transform or a Fourier transform for the captured image.

10. An information processing apparatus comprising:
a memory storing instructions; and
a processor configured to execute the instructions to:
convert a captured image into first frequency characteristic data;
generate second frequency characteristic data by excluding data of a predetermined area from the first frequency characteristic data; and
determine whether or not the captured image is blurred based on the second frequency characteristic data,
wherein the processor determines the predetermined area according to whether or not the predetermined area falls within a predetermined range based on a statistic obtained based on the first frequency characteristic data.

11. A non-transitory computer-readable storage medium storing computer-executable instructions that, when executed by a computer, cause the computer to execute a method comprising:
a conversion step of converting a captured image into first frequency characteristic data;
a generation step of generating second frequency characteristic data by excluding data of a predetermined area from the first frequency characteristic data; and
a determination step of determining whether or not the captured image is blurred based on the second frequency characteristic data,
wherein in the generation step, the predetermined area is determined according to whether or not the predetermined area falls within a predetermined range based on a statistic obtained based on the first frequency characteristic data.
